(19) United States
(12) Patent Application Publication
(10) Pub. No.: US 2004/0258523 A1
(43) Pub. Date: Dec. 23, 2004

(54) Sealing assembly

(76) Inventors: Shailendra Naik, Gebenstorf (CH); Ulrich Rathmann, Baden (CH)

Correspondence Address: COLLIER SHANNON SCOTT, PLLC, 3050 K STREET, NW, SUITE 400, WASHINGTON, DC, 20007, US

(21) Appl. No.: 10/865,761

(22) Filed: Jun. 14, 2004

Related U.S. Application Data
(63) Continuation of application No. PCT/CH02/00687, filed on Dec. 12, 2002.

(30) Foreign Application Priority Data
Dec. 13, 2001 (CH) CH 2001 2280/01

(51) Int. Cl. F03D 1/00

(52) U.S. Cl. 416/116

(57) ABSTRACT

A sealing assembly for contactless sealing between static components and moving components of a gas turbine comprises a gas-permeable, abrasion-tolerant sealing element arranged opposite a sealing tip and secured in a support. In operation, a coolant can flow through the sealing element, for example a honeycomb element, due to its gas permeability, so the sealing element is cooled. A redundant coolant passage opens upstream of the sealing element on the hot-gas side of the assembly, so that coolant emerging therefrom flows over the sealing element on its hot-gas side. If the flow of coolant through the sealing element fails because flow through the sealing element becomes blocked, cooling is taken over by film coolant flowing out of the redundant cooling passage. Coolant mass flow is metered in via feeds, which effect the primary pressure loss in the device. The feeds may be designed as through-openings in an impingement cooling element.

### CROSS-REFERENCE TO RELATED APPLICATIONS

This application is a continuation of the U.S. National Stage designation of co-pending International Patent Application PCT/CH02/00687 filed Dec. 12, 2002, the entire content of which is expressly incorporated herein by reference thereto.

### FIELD OF THE INVENTION

The present invention relates to a sealing assembly. The present sealing assembly can be used in particular for contactless sealing between components that move with respect to one another in regions in which the seal is exposed to a high thermal load. One particular application area in this context is use in turbomachines, in particular in gas turbines, for reducing leak streams that inevitably occur, for example, between the rotor blades and the housing or between rotor blades and the rotor. Of course, however, there also are other possible uses in regions in which a cooled sealing assembly is advantageous.

### BACKGROUND OF THE INVENTION

The efficiency of a gas turbine is influenced, inter alia, by leak streams of the compressed gas that occur between the rotating and non-rotating components of the turbine. The gap which is necessarily present between the tips of the rotor blades and the housing wall surrounding the rotor blades plays a significant role in this context. Reducing the size of these gaps conceals the latent risk of stripping. Therefore, stripping elements or stripping coatings which are mechanically soft are often used as sealing elements, allowing possible stripping of the rotor blade tips to be absorbed by their own deformation. This prevents damage to the rotating parts, and it is ensured that the machine is able to tolerate possible stripping. Honeycomb seals or sealing elements made from abrasion-tolerant materials, for example porous foams or felts, often are used. Both the tips of the rotor blades or guide vanes and the honeycomb seals that are used are exposed to very high temperatures in hot-gas operation of the gas turbine. It is therefore desirable and often even necessary for the blade tips and the sealing elements to be cooled.

For example, it is known from U.S. Pat. No. 3,365,172 for cooling air to be applied to the sealing tips of the rotor blades through the honeycomb seals at the blade strip. For this purpose, the support for the honeycomb seals has small cooling-air bores passing through it, and these bores are supplied with cooling air via an encircling annular chamber.

JP 61149506 shows a similar configuration, in which the honeycomb seals are supported by a layer of porous metal which adjoins a feed chamber for cooling air. In this configuration too, the cooling air is passed to the blade tips through the honeycomb seals.

EP 0 957 237 or U.S. Pat. No. 6,171,052 has disclosed the cooling of a honeycomb seal for producing a seal between the blade tips and the housing of a gas turbine. According to the teaching disclosed by those documents, the sealing assembly has two sealing elements in honeycomb form which simultaneously serve as stripping coatings and of which one is arranged so as to seal off an axial leakage gap and one is arranged so as to seal off a radial leakage gap. The sealing elements in honeycomb form are arranged on a support ring in which there is formed an annular space that is in fluid communication with sealing elements. Cooling medium is supplied to the annular space via feed passages and flows out through the cavities in the honeycomb seals. This configuration firstly results in homogenous distribution of the cooling medium over the entire sealing ring. Secondly, the coolant flowing through the honeycombs is responsible for cooling both the honeycombs and the sealing tips of the rotor blades and/or blade cover strips.

Configuring the sealing arrangement in this way gives rise to the problem whereby the honeycomb seals may become smeared over large parts of the circumference, for example as a result of soiling, foreign bodies or also stripping, with the result that the mass flow of cooling air which emerges is considerably reduced. This leads to failure as a result of overheating and accelerated oxidation or corrosion of the honeycomb material. If the honeycomb seals simultaneously serve as an outlet for an upstream cooling system, blockages in these outlet regions can cause the upstream component cooling to fail, with the associated adverse consequences.

### SUMMARY OF THE INVENTION

Working on the basis of this prior art, the present invention relates to providing a sealing assembly of the type described in the introduction that avoids the drawbacks of the prior art. The present invention in particular relates to ensuring sufficient cooling even in the event of the structures of the sealing assembly that are permeable to cooling medium and are relatively soft, and therefore tolerant of stripping, becoming blocked. The sealing assembly according to the invention has proven very particularly suitable for use in turbomachines, such as gas turbines, for contactless sealing between rotating and stationary components in the hot-gas region.

The core of the invention is to design the sealing assembly in such a way that a redundant coolant path is formed. According to the invention, at least one redundant coolant passage branches off from the coolant feed in the gas-permeable sealing assembly, in such a manner that a first coolant flow path, which leads to the sealing elements and through the sealing elements, with the result that transpiration cooling of the gas permeable sealing elements is basically realized, and a redundant coolant flow path are formed, with the redundant coolant passage opening out in the hot-gas flow preferably upstream, as seen in the direction of the hot-gas flow to be sealed off, of the gas-permeable element, on the hot-gas side of the sealing assembly. The first coolant path, or transpiration cooling path, in this case therefore leads through gas-permeable soft sealing elements, whereas the redundant coolant passage is routed within a supporting structure that is not gas-permeable and is generally mechanically rigid. In an advantageous embodiment, the redundant coolant passage is designed in such a way that the coolant which emerges there through redundant coolant openings, in particular cooling air, opens out at least approximately parallel to the wall of the hot-gas side, in such a manner that the coolant which emerges there is passed as a cooling film over the gas-permeable sealing element, in particular a honeycomb seal, or a porous metal or ceramic element. Therefore, transpiration cooling of the gas-permeable sealing elements as designed is combined with redundant film cooling of the gas-permeable sealing elements. This is also achieved particularly successfully if the redundant coolant passage is inclined in the direction of the hot-gas flow, in particular in such a manner that the coolant part-stream passing through it emerges from the redundant coolant openings at an angle of preferably less than 30° with respect to the leakage flow which is flowing past. In normal operation, with a design in accordance with the invention, a proportion of the coolant is passed directly through the gas-permeable sealing element for transpiration cooling, in an inherently extremely efficient way, while a second coolant stream emerges through the redundant coolant openings. In a preferred embodiment, the passage cross-sections of the sealing elements and of the redundant coolant openings and/or passages can be dimensioned in such a manner that, in normal operation, only a relatively small proportion of the overall mass flow of coolant passing through the sealing assembly, amounting to less than 50%, in particular less than 30%, passes through the redundant coolant openings. Should the passage openings in the gas-permeable sealing element then become blocked, the pressure loss across the first coolant path increases, and the efficiency of the transpiration cooling is reduced. The coolant flow is then shifted from the gas-permeable element to the redundant coolant passage, and the proportion of the coolant that can no longer pass through the gas-permeable sealing element, on account of the increased flow resistance, flows out onto the hot-gas side through the redundant coolant outlet opening and, with a preferred orientation of the redundant coolant passage such that coolant emerging through the redundant coolant opening at least in part flows over the sealing element, forms a cooling film over the sealing element. In this context, it is advantageous if the coolant that emerges through the redundant coolant openings emerges substantially parallel to the front side of the gas-permeable sealing element. In this way, at least adequate cooling of the sealing elements is ensured even if a through-flow of coolant as designed is prevented, by virtue of a redundant overflow of coolant.

In addition, it also should be noted that the flow of coolant out into the sealing gap, i.e. the leakage flow, in any event also improves the sealing action, since at least part of the sealing gap cross-section is acted on by the coolant, and therefore the hot-gas flow is displaced out of the sealing gap. Therefore, the gas-permeable element is preferably designed and arranged in such a way that the coolant stream passing through opens out in the leakage flow and includes an angle of more than 45° with the latter, preferably indeed being oriented normally to the leakage flow.

In a preferred embodiment of the invention, the sealing element is designed as a honeycomb seal. In a further embodiment, the sealing element consists of a porous material. In this context, consideration could be given, for example, to a porous metal foam or metal felt, or to a porous ceramic, in particular a ceramic foam or a ceramic fiber felt.

If used in a turbomachine, the sealing assembly according to the invention is designed in such a manner that the outlet opening of the redundant coolant passage is located upstream of the sealing element, with regard to the flowing hot gases or the leakage flow, in such a way that the coolant is guided over the sealing element.

In one embodiment of the invention, the assembly has at least one chamber, which is in fluid communication both with the coolant feed and with a gas-permeable sealing element. The purpose of the chamber is in particular to distribute the coolant across the entire sealing element.

In a refinement of the sealing assembly according to the invention, the support has a plurality of chambers and a plurality of feeds, with at least one feed opening into each chamber, and each chamber being in communication with at least one sealing element. In this case, each chamber is assigned to a segment, with each segment being completely separate from the other segments with regard to the through-flow of coolant. The segmented design has the additional effect that in the event of a segment failing as a result of blockage or mechanical damage, the cooling action of the further sealing element segments of the sealing assembly is not impaired.

Although the following exemplary embodiment and also the preceding explanation in each case make reference to turbomachines, it will be clear to the person skilled in the art that the sealing assembly according to the invention also can be used in other regions in which the corresponding conditions for a suitable coolant to flow through or onto the sealing assembly are present.

### BRIEF DESCRIPTION OF THE DRAWINGS

The sealing assembly according to the invention is explained again briefly below on the basis of an exemplary embodiment and in conjunction with the drawings, in which:

FIG. 1 shows an example of the use of an embodiment of a sealing assembly according to the invention in a sealing device for sealing off leak streams between the rotor blade and the housing of a turbomachine;

FIG. 2 shows a cross-section through the arrangement illustrated in FIG. 1; and

FIG. 3 shows a further preferred embodiment of the invention.

### DETAILED DESCRIPTION OF THE PREFERRED EMBODIMENTS

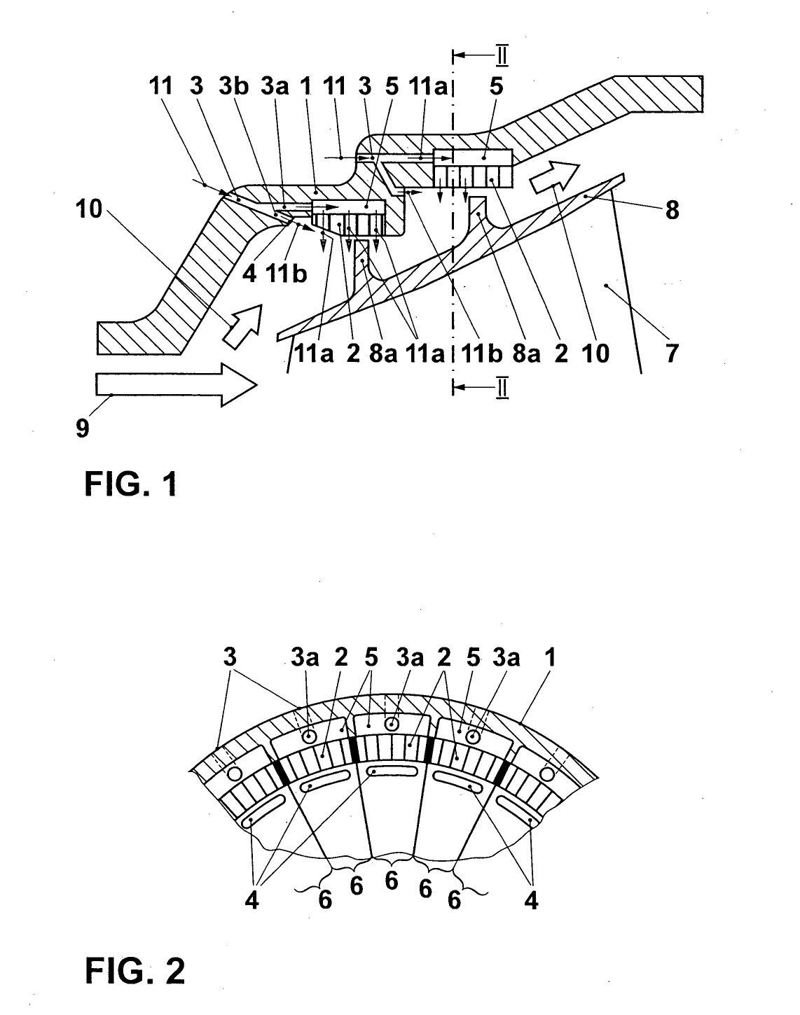

FIG. 1 shows an example of the use of an embodiment of a sealing assembly according to the invention for sealing off leakage streams between the tip of a rotor blade 7, or a blade cover strip, and the housing, which is not illustrated in detail, of a turbomachine. A hot gas flow 9 flows onto the rotor blade. The direction of flow of the hot gas in this example runs from the left to the right. A sealing gap, through which a leakage flow 10 which is to be sealed off flows, is formed between the blade tips and the housing of the gas turbine or the sealing assembly. The sealing assembly according to the invention, together with a component which moves relative to it and is located opposite a sealing surface, in the present case the sealing tips 8a of the blade cover strip 8, forms a contactless sealing device that reduces the leak mass flow. A support 1 bears sealing elements 2 located directly opposite the sealing tips 8a on the side which hot gas flows over. The sealing elements, together with the sealing tips 8a, form extremely narrow cross-sections of the leakage gap. The narrower these cross-sections, the smaller the leakage stream. On account of the narrow gap dimension, in the event of deviations from the stipulated design, there is a risk of the rotating sealing tips being stripped against the stationary sealing elements. The sealing elements are therefore designed to tolerate stripping, so that they are able to absorb stripping through deformation without causing serious mechanical damage. These sealing elements are preferably honeycombs or porous metal or ceramic structures. In operation, hot gas flows over the sealing elements, and these elements, on account of their porosity, are susceptible, inter alia, to overheating and corrosion. According to prior art, therefore, coolant, for example cooling air, flows through the porous and/or gas-permeable sealing elements. The cooling air 11 flows in via a feed 3, and in the exemplary embodiment a part-stream 11a of the cooling air is guided into a chamber 5, from where it flows out through cavities in the sealing element 2, with the sealing element being cooled. In the process, the chamber distributes the coolant as uniformly as possible over the sealing element. Should the cross-sections of flow then become closed up, the sealing element is no longer cooled as designed. According to the invention, therefore, a redundant coolant passage branches off from the coolant flow path 3a and 5 which leads to the rear side of the sealing element, and this redundant coolant passage opens out in a redundant coolant opening 4 on the hot-gas side of the solid, inherently gas-impermeable support. This opening is arranged upstream of the sealing element 2, as seen in the direction of the flow which is to be sealed off, and the coolant passage opens out in such a way that the redundant part-stream 11b of coolant emerges from the second part-passage substantially parallel to the sealing element and to the leakage flow. The redundant cooling-air flow therefore forms a cooling film over the sealing element. Suitably configuring the cross-sections of flow of the various coolant paths allows the design coolant mass flows to be deliberately divided in such a way that, for example in undisturbed normal operation, a relatively small part-stream, for example less than half the total cooling mass flow of the sealing assembly, flows via the redundant passage and through the redundant coolant openings 4. If the flow of coolant through the sealing element 2 is then impeded, the flow of coolant through the redundant flow path 3b increases—in particular on condition that the cooling system is designed in such a way that a significant pressure drop occurs upstream of the branch in the flow path, in particular in the region of the feed 3—and the increasing film cooling of the sealing element 2 compensates for the drop in cooling provided by the through-flow at least to a sufficient extent to ensure sufficient cooling of the sealing element and its ability to function in the long term.

FIG. 2 shows a cross section through the device illustrated by way of example. The arrangement of the sealing elements is divided into segments 6 in the circumferential direction. Each of the sealing elements 2 in a segment is fed with cooling air from a single chamber 5 in each case with a separate feed 3, 3a. The chambers 5 are separate from one another in the circumferential direction by webs of the support 1. A redundant cooling passage 3b, which cannot be seen in this view and has a redundant coolant outlet opening 4, branches off from each feed 3. As can be seen, the redundant coolant openings 4 are designed in the manner of slots, so that in each one circumferential segment of the sealing elements 2 is covered as completely as possible by the film-cooling air flow. The supply of cooling air to the sealing elements 2 is therefore divided in the circumferential direction into a number of completely independent subsystems. This arrangement of a plurality of separate chambers 5 for the cooling medium, which are in direct contact with the individual sealing element segments 2, limits damage to the seal, for example caused by individual segments being torn out, to the regions which are actually affected and prevents further temperature-induced damage to the remaining sealing sections as a result of the upstream cooling-air pressure failing. In an intermediate situation of this type, only the pressure of the cooling medium in the affected chamber fails. Adjacent chambers are not affected by this. In this case, the feeds 3, 3a have a considerably smaller cross-section than the chambers themselves, so that the feeds act as throttling locations for metering in the cooling-air mass flow. The cooling action in the remaining segments is in this case not significantly affected in the event of damage to one segment, on account of this particular configuration, with the result that the remaining segments of the sealing element 2 continue to be cooled as designed.

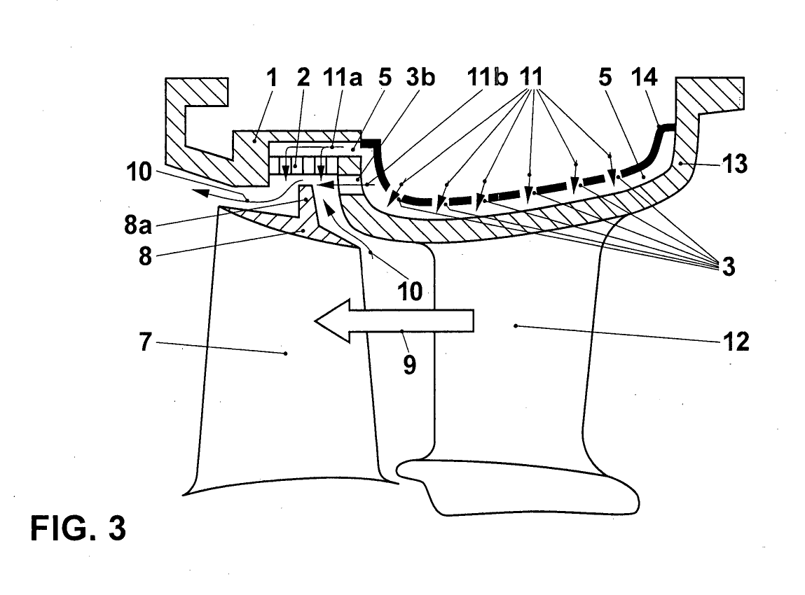

A further preferred embodiment of the invention is illustrated in FIG. 3. The assembly according to the invention is produced for the purpose of sealing off the hot-gas flow between the moving parts and a gas turbine. As well as the rotor blade 7, the guide vane 12 which precedes it in the direction of flow is also illustrated. The hot-gas flow 9 is oriented from the right to the left. A gas-permeable sealing element 2 is arranged in the stator on a support 1, opposite the sealing tip 8a of the rotor blade cover strip 8, the intention being that the sealing tip 8a and the sealing element together should minimize the leakage stream 10. The root 13 of the guide vane is designed with impingement cooling. For this purpose, there is an impingement cooling insert 14, which is perforated and passes coolant with a high momentum onto the cooling side of the blade root, where the coolant takes up heat from the material of the guide vane root 13. The perforation of the impingement cooling insert or impingement cooling plate 14 in this case simultaneously serves as a feed 3 for metering in the coolant 11. After it has flowed through the impingement cooling insert and after cooling of the guide vane root has taken place, the coolant is located in a chamber 5 that is substantially surrounded by the blade root 13, the impingement cooling insert 14, the support 1 and the sealing element 2. The arrangement of the assembly is once again circumferentially symmetrical. In this case, the chamber may advantageously likewise, together with the impingement cooling insert, be segmented in particular in the circumferential direction, analogously to the example illustrated in FIG. 2. From the chamber, the coolant flows to the sealing element 2. In the process, a portion 11a of the coolant flows through the sealing element to the hot-gas side, and a second portion 11b flows through the redundant coolant passage 3b as film-cooling air over that side of the sealing element that faces the hot gas. The cross-section of the redundant coolant passage is advantageously dimensioned in such a way, for example by means of a throttling location, that the coolant 11, in normal operation, substantially flows out of the chamber 5 through the sealing element 2. In the case of impingement cooling, the pressure loss across the feeds is relatively great, and with the coolant routing illustrated the majority of the pressure loss will substantially occur across the impingement cooling insert 14, in such a manner that the impingement cooling insert meters in the overall mass flow of the coolant 11 substantially independently of the components arranged downstream. If the openings in the gas-permeable sealing element become blocked for whatever reason, the overall mass flow, given a suitable design of the cross-sections of flow, accordingly remains approximately constant, and the coolant mass flow in the sealing element 2 is shifted into the redundant cooling passage 3b as film-cooling air. The redundant coolant passage arranged in accordance with the invention therefore ensures firstly a minimum cooling of the sealing element, and secondly maintains the flow through the impingement cooling insert 14 and therefore the impingement cooling of the blade root 13.

Of course, the invention is not restricted to the exemplary embodiments; by contrast, in view of the statements given above, a wide range of possible embodiments of the invention characterized in the claims will become apparent to the person skilled in the art.

### List of Designations

1 support

2 sealing element

3 feed

3a coolant passage

3b redundant coolant passage

4 outlet opening of the redundant coolant passage, redundant coolant opening, redundant cooling-medium opening

5 chamber

6 segment, circumferential segment

7 rotor blade

8 rotor blade cover strip

8a sealing tips

9 hot-gas flow

10 leakage flow

11 coolant flow, cooling-air flow, cooling medium

11a coolant part-stream

11b coolant part-stream, film-cooling air

12 guide vane

13 guide vane root

14 impingement cooling insert, impingement cooling plate

What is claimed is:

1. A sealing assembly for components of a turbomachine comprising:
a cooling side;
a hot-gas and sealing side over which hot gas flows in operation;
at least one gas-permeable sealing element arranged on the sealing side, the sealing element having a front side that forms a sealing surface and faces toward the hot-gas and sealing side, and a rear side that faces toward the cooling side;
at least one feed for a coolant in fluid communication with the rear side of the gas-permeable sealing element, a coolant mass flow being permitted to flow through the sealing element in operation;
wherein at least one redundant coolant passage branches off in a coolant flow path between the at least one feed and the rear side of the gas-permeable element, with the at least one redundant coolant passage having a redundant coolant opening proximate the gas-permeable sealing element on the hot-gas and sealing side.

2. The sealing assembly of claim 1, wherein the redundant coolant opening is arranged upstream of the sealing element, in a direction of a hot-gas flow, on the hot-gas and sealing side.

3. The sealing assembly of claim 1, wherein a coolant stream flowing through the gas-permeable element is received in a leakage flow, and includes an angle of more than 45° with the leakage flow.

4. The sealing assembly as claimed in claim 3, wherein the coolant stream flowing through the gas-permeable element is received substantially normally with respect to the leakage flow.

5. The sealing assembly of claim 1, wherein the at least one redundant coolant passage is inclined in a direction of a leakage flow.

6. The sealing assembly of claim 5, wherein the at least one redundant coolant passage is arranged to direct coolant through the redundant coolant opening at an angle of less than 30° with respect to the leakage flow.

7. The sealing assembly of claim 1, wherein the at least one redundant coolant passage is arranged to direct coolant through the redundant coolant opening to at least partially flow over the sealing element.

8. The sealing assembly of claim 1, wherein the redundant coolant passage is arranged to direct coolant at least in part approximately parallel to the front side of the sealing element of the sealing assembly on the hot-gas side.

9. The sealing assembly of claim 1, further comprising at least one chamber in fluid communication with both the feed and the gas-permeable sealing element.

10. The sealing assembly of claim 9, wherein the chamber comprises a plurality of separate chambers receiving a plurality of feeds, with at least one feed opening into each chamber, with each chamber being in fluid communication with the rear side of one of the at least one gas-permeable sealing element, and each chamber being assigned to a segment.

11. The sealing assembly of claim 10, wherein an individual sealing element is arranged in each segment.

12. The sealing assembly of claim 10, wherein at least one redundant coolant passage with a redundant coolant opening is arranged in each segment.

13. The sealing assembly of claim 12, wherein an individual sealing element is arranged in each segment.

14. The sealing assembly of claim 1, wherein the feed is integrated in an impingement cooling insert.

15. The sealing assembly of claim 1, wherein the coolant is cooling air.

16. The sealing assembly of claim 1, wherein the redundant coolant opening comprises a slot.

17. A sealing assembly for components of a turbomachine comprising:
a gas-permeable sealing element;
a coolant passage open to a cooling side of the assembly, the coolant passage having a first branch starting upstream of the sealing element and leading to a leakage flow of a hot gas flow, and a second branch leading to the sealing element;
wherein a coolant mass flow is permitted to flow through the sealing element and be received in the leakage flow during operation of the turbomachine.

18. The sealing assembly of claim 17, wherein the first branch is oriented to direct coolant to at least partially flow over the sealing element.

19. The sealing assembly of claim 17, wherein the second branch leads to a chamber in fluid communication with a rear side of the sealing element.

20. The sealing assembly of claim 19, wherein the chamber permits coolant to be uniformly distributed over the rear side of the sealing element.

21. The sealing assembly of claim 17, wherein at least two of the gas-permeable sealing elements and at least two of the coolant passages are provided, wherein the coolant passages are independent of each other.

22. The sealing assembly of claim 17, wherein the coolant passage is oriented to deliver coolant to the leakage flow at an angle of less than 30° with respect to the direction of the leakage flow.

23. The sealing assembly of claim 17, wherein the first branch comprises a slot in communication with hot gas flow.

24. The sealing assembly of claim 17, wherein the first branch is configured and dimensioned to provide film-cooling over a surface of the sealing element.

25. The sealing assembly of claim 17, wherein the sealing element is configured and dimensioned to deliver coolant to the leakage flow at an angle of more than 45° with respect to the direction of the leakage flow.

26. The sealing assembly of claim 17, wherein coolant flowing through the gas-permeable element is received substantially normally with respect to the leakage flow.

27. The sealing assembly of claim 17, wherein the first branch opens proximate a surface of the sealing element.

28. The sealing assembly of claim 17, wherein the coolant is cooling air.
